(19) United States
(12) Patent Application Publication
(10) Pub. No.: US 2021/0086327 A1
(43) Pub. Date: Mar. 25, 2021

(54) An Engraving Machine and Method for Engraving Building Material Articles, Preferably Slabs

(71) Applicant: SCG BUILDING MATERIALS CO., LTD., BANGKOK (TH)

(72) Inventors: Thanawat KRAINITHISOM, BANGKOK (TH); Suriya CHUENAROM, BANGKOK (TH); Terdwong JAMRUSSAMEE, BANGKOK (TH); Chokthakun IAMWICHAN, BANGKOK (TH)

(21) Appl. No.: 16/499,153

(22) PCT Filed: Mar. 22, 2018
(86) PCT No.: PCT/IB2018/051921

§ 371 Date: Sep. 27, 2019

(30) Foreign Application Priority Data
Mar. 27, 2017 (IT) 102017000033449

(51) Int. Cl. B24C 1/04; B24C 5/04

(52) U.S. Cl. CPC B24C 1/045; B24C 5/04

(57) ABSTRACT

An engraving machine for engraving building material articles comprises a working plane on which, in use, at least one building material article rests, and defining a working area having a predetermined width, an engraving device facing the working plane and equipped with at least one reservoir for containing an abrasive particulate material, and an array of nozzles for delivering the abrasive particulate material configured for making a predetermined engraving path on the article, and moving means configured to determine a relative sliding between the working plane and the engraving device along a movement direction transverse to the predetermined width. The nozzles of the array are arranged in succession along a direction transverse to the movement direction to fully cover said predetermined width. A control unit is and configured to drive associated nozzles independently of each other.

### CROSS-REFERENCE TO RELATED APPLICATIONS

This application is a US 371 Application from PCT/M2018/051921 filed Mar. 22, 2018, which claims priority to Italian Application 102017000033449 filed Mar. 27, 2017, the technical disclosures of which are hereby incorporated herein by reference.

The present invention relates to a machine and a method for engraving building material articles, preferably slabs.

Therefore, the present invention finds particular application in the field of the ceramic industry, in particular in making engravings and/or veinings on slabs or tiles by sandblasting.

In the ceramic or marble industry, in fact, it is common practice to make engravings on slabs or tiles in order to create particular patterns or drawings, as well as to try to process them in order to create veinings that recall, in whole or in part, the appearance of natural stones.

In order to achieve this goal, several solutions have been presented over the years, which were mainly focused on the possibility of making engravings of different widths and/or depths on the exposed face of the slab, most of which based on the use of a pre-cut and pre-applied mask shaped so as to reproduce the processing to be performed.

For example, US document U.S. Pat. No. 5, 069,004 shows an engraving methodology comprising a step of applying a magnetically interactive coating having a series of “voids” corresponding to the geometry of the engravings to be performed.

Similarly, document EP0824990 provides for the application of a polyester surface mask or template having a suitably perforated pattern; such a mask being able to resist the abrasion made by the particulate material delivered by the engraving nozzles.

Furthermore, Japanese document JP2003089060 describes a system providing a perforated mask and in which a series of nozzles arranged along the whole length/width of the slab are activated simultaneously to impact the “masked” surface of the slab, wherein engravings are therefore only allowed in the perforated areas of the mask.

Other examples of such embodiments are known from numerous prior art documents, which however fully describe systems that require a preliminary formation of the “ perforated mask”, by means of presswork, chip machining or the like.

Disadvantageously, this solution greatly limits the flexibility of the system, since each variation in the geometry of the engraving requires a new mask, thereby also impacting on production costs.

Further solutions, for example known from document U.S. Pat. No. 5,643,057, used for different types of applications, instead, comprise analytically determining the distance at which the engraving nozzles are to be applied with respect to the surface of the slab, and actuating the same in a homogeneous manner in order to recreate an evenly engraved surface over the entire slab.

Clearly, although overcoming the problem of requiring a mask, the U.S. Pat. No. 5,643,057 solution does not allow any differentiation in the geometry of the engraving, both in terms of design and depth.

The object of the present invention is therefore to provide a machine and a method for engraving, preferably by sandblasting, a building material article, preferably a ceramic slab, which are capable of obviating the above-mentioned drawbacks of the prior art.

In particular, the object of the present invention is to provide a machine and a method for engraving a building material article, preferably a slab, which are particularly versatile and able to adapt to a plurality of engraving geometries.

In addition, the object of the present invention is to provide a machine and a method for engraving a building material article, which are accurate and easy to implement.

Said objects are achieved by means of a machine for engraving a building material article having the features of one or more of the subsequent claims 1 to 8, as well as by a method for engraving a building material article according to one or more of the claims 9 to 13.

In particular, the engraving machine comprises a working plane on which, in use, at least one building material article, preferably a slab, rests, and defining a working area having a predetermined width.

An engraving device faces the working plane. This device is provided with at least one reservoir for containing an abrasive particulate material and an array of nozzles for delivering said abrasive material, the nozzles being configured for making a predetermined engraving path on said article.

The nozzles of the array are preferably arranged in succession along a direction such as to cover the entire width of the working area.

According to one aspect of the present invention, the machine comprises a control unit associated with said nozzles and configured to drive them independently of each other in order to adapt the engraving to the conformation of said predetermined engraving path.

It should be noted that the predetermined engraving path preferably defines, on the article, a plurality of first portions, to be engraved, and a plurality of second portions, without engravings.

The control unit is thus configured to activate the nozzles of the array (only) when they directly face a first portion of the article and deactivate the nozzles of the array (or keep them deactivated) when they directly face a second portion of the article.

Preferably, moreover, the machine comprises moving means configured to determine a relative sliding between said working plane and said engraving device along a movement direction transverse to said predetermined width of the working area.

The nozzles are therefore arranged in the array in succession along a direction transverse, preferably orthogonal, to the direction of movement.

Advantageously, this allows the number of nozzles required for the complete processing of the article to be reduced, such that the independent operation of the same, together with the movement relative to the plane, enables any type of processing.

It should be noted that the engraving device preferably comprises at least one array of first nozzles and one array of second nozzles arranged in succession along said direction of movement.

Preferably, the first nozzles have a different size (understood as the section of the delivery outlet) from the second nozzles.

Advantageously, in this way, the first and second nozzles can work and deliver abrasive material of different particle sizes, allowing the creation of engravings of different widths by a single-pass sandblasting.

Preferably, moreover, each nozzle of the array (or of each array) is movable towards and/or away from the working plane to vary the contact pressure of the abrasive material particles on the article.

In certain embodiments, not shown, the nozzles are movable towards and away from the working plane in a mutually independent manner, even within the same array.

The object of the present invention, as already underlined several times, is also a method for engraving a building material article, preferably a ceramic slab.

This method comprises providing a building material article on a working plane; said article having a predetermined width.

The determination of a predetermined engraving path to be made on the article is then provided.

Preferably, the engraving path is variegated. In particular, this engraving path comprises a plurality of wide engravings and a plurality of narrow engravings. Furthermore, alternatively or additionally to the above, the engraving path preferably comprises a plurality of deep engravings and a plurality of superficial engravings.

Once the engraving path has been defined, an engraving device facing the working plane and provided with an array of nozzles extending such as to fully cover said predetermined width of the article is then operated. The nozzles are configured for delivering an abrasive particulate material on the article in order to engrave it.

Preferably, the engraving device comprises at least one array of first nozzles, of a larger size, and a second array of second nozzles, of a smaller size; alternatively, the arrays may also be more than two, for example three and defining nozzles with a maximum size, a minimum size and an intermediate size.

According to one aspect of the present invention, the step of operating the nozzles comprises activating the nozzles of the array (only) when they directly face a first portion of the article and deactivating the nozzles of the array when they directly face a second portion of the article.

It should be noted that each nozzle is preferably operated independently and autonomously of the others when it faces a portion of the engraving path.

Advantageously, this allows the engravings to be made by only operating the relevant nozzles and consequently operating them, overcoming the need for a protective mask and limiting the consumption of abrasive material.

Preferably, moreover, the step of operating the nozzles comprises operating one or more of the first nozzles to make a wide engraving and operating one or more of the second nozzles to make a narrow engraving.

More preferably, the second nozzles are operated earlier than the first, so that it is possible to further groove a wide engraving with a narrow veining.

Moreover, preferably, nozzles of a same array may also make engravings of different depths. In this regard, the method preferably comprises positioning each nozzle (i.e. array of nozzles) in a position proximal to the article to increase the contact pressure of the abrasive particulate material and make a deep engraving and/or positioning each nozzle (i.e. array of nozzles) in a position distal to the article to reduce the contact pressure of the abrasive particulate material and make a superficial engraving.

These and other features, together with the advantages related thereto, will become more apparent from the following illustrative, and therefore not limiting, description of a preferred, thus not exclusive, embodiment of a machine and method for engraving a building material article as shown in the accompanying drawings, wherein:

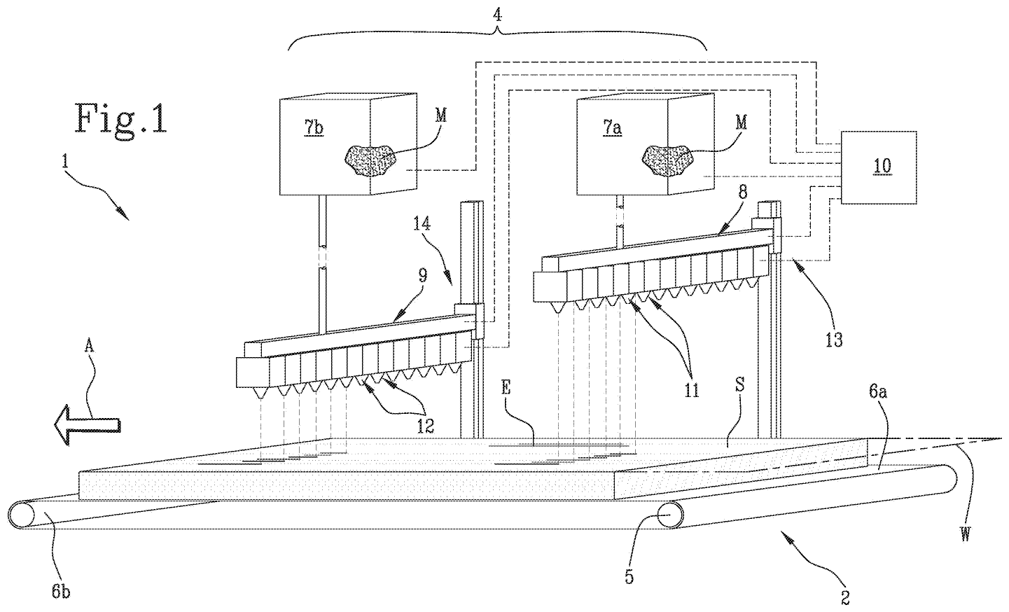

FIG. 1 schematically shows a machine for engraving building material articles according to the present invention in a perspective view;

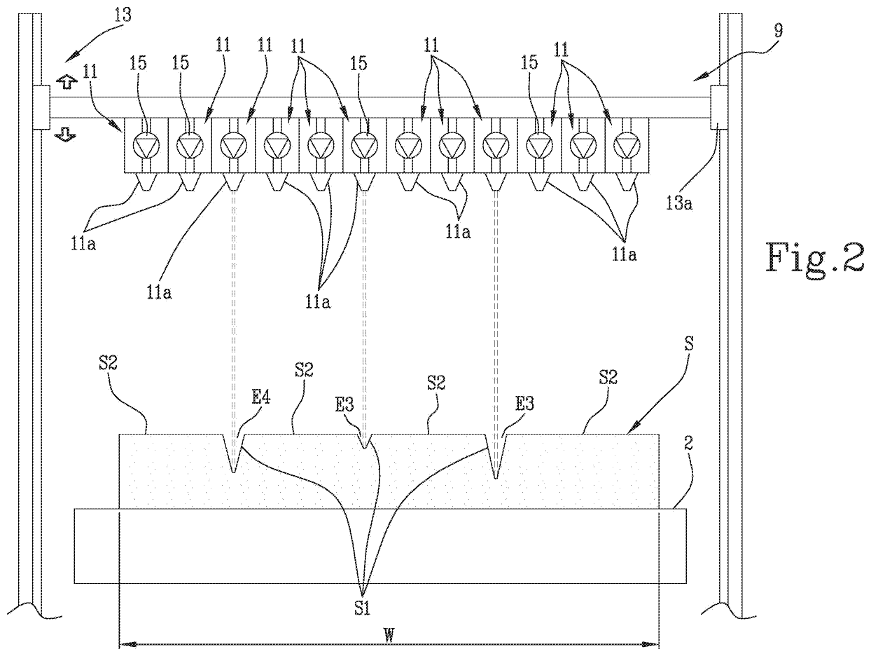

FIG. 2 is a schematic view of a cross-section of the machine of FIG. 1;

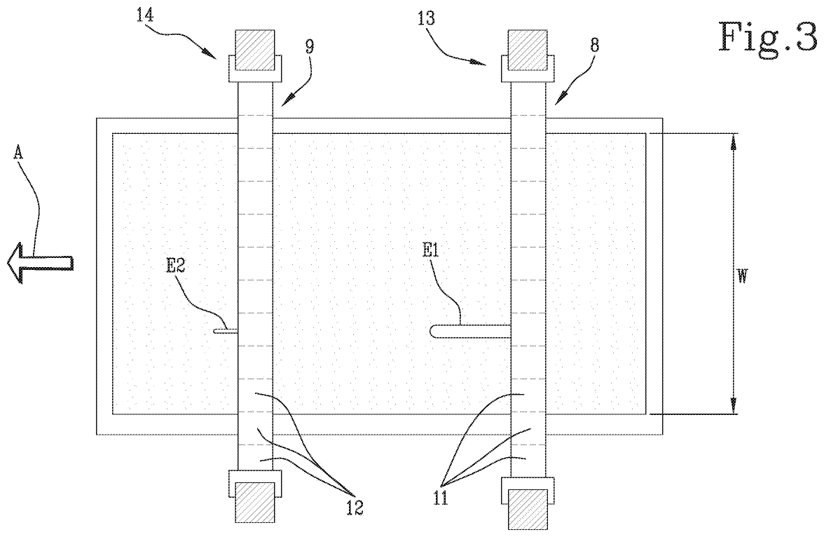

FIG. 3 is a schematic plan view of the machine of FIG. 1.

With reference to the accompanying figures, the numeral 1 indicates an engraving machine for engraving a building material article.

Preferably, in the accompanying figures the illustrated article “S” is a slab, preferably a ceramic slab.

For this reason, without thereby losing generality, the following description will make explicit reference to a slab “S” in place of a generic article; however, it will be apparent to a person skilled in the art that everything related to the slab can be referred to a generic article, compatibly with its structure.

Preferably, the slab “S” is made of a ceramic material or alternatively of marble, stone or concrete.

The engraving machine 1 therefore finds a preferred application in the engraving of slabs for decorative purposes, both for creating drawings and for reproducing graphic effects typical of natural stones.

More precisely, the engraving machine 1 is configured to perform a localised sandblasting of the slab, engraving it by high-speed ejection of abrasive particulate material.

The abrasive material “M” can preferably be sand (e.g. silica sand), but could also be of a different nature, provided it is hard enough to engrave the slab.

Examples of abrasive materials that can be used by the engraving machine 1 can be one or more of the following:

cast steel grains;

hard ceramic grains;

tungsten carbide;

silicon carbide.

Structurally, the engraving machine 1 comprises a working plane 2, on which, in use, the slab “S” rests, and an engraving device 4, which, in use, at least partially faces the working plane 2.

In the preferred embodiment (FIG. 1), the working plane 2 is preferably horizontal.

However, there are embodiments, not shown, wherein the working plane 2 is arranged inclined with respect to the horizontal plane, or in certain cases, is arranged vertically.

The working plane 2 therefore defines a working area of the machine 1. This working area has a predetermined width “W”, which is preferably equal to or greater than the corresponding width of the slab “S”.

Preferably, the machine 1 comprises moving means 5 configured to determine a relative sliding between the working plane 2 and the engraving device 4 along a movement direction “A”.

The moving means 5 are particularly configured to impart to the working plane 2 and/or to the engraving device 4 a sliding movement transverse to the aforementioned width “W” of the working area (and therefore to the width of the slab “S”).

Preferably, the movement direction “A” is therefore transverse, more preferably orthogonal, to the width “W” of the working area.

The moving means 5 are therefore operatively interposed between the working plane 2 and the engraving device 4.

Preferably, in order to simplify the construction and control of the machine 1, the moving means 5 are associated with the working plane 2.

In the preferred embodiment, therefore, the working plane 2 is defined by a conveyor belt 6a driven by a motor 6b. Said belt 6a and said motor 6b, therefore, define the moving means 5.

The engraving device 4 comprises at least one reservoir 7a, 7b, for containing an abrasive particulate material “M”, and an array 8, 9 of nozzles 11,12, for delivering said abrasive material

In certain embodiments, the engraving device 4 comprises intermediate containers (not shown) arranged between the reservoir 7a, 7b and each nozzle 11, 12 (or group of nozzles) so as to reduce the portion of the conduit travelled by the material and to make the action of the device readier.

The engraving device 4, and in particular the nozzles 11, 12, are configured to provide a predetermined engraving path “E” on the slab “S”.

This engraving path “E” therefore defines, on said slab “S”, a plurality of first portions S1, to be engraved, and a plurality of second portions S2, without engravings.

Preferably, the engraving device 4 comprises a pressure generator 15 associated with each nozzle 11, 12 and configured to create an overpressure or a vacuum such as to eject the abrasive material “M” coming from the reservoir 7a, 7b through the nozzle 11, 12 at a predetermined pressure.

Preferably, the pressure generator 15 comprises a vacuum pump and/or generator associated with the nozzle and configured to determine the delivery pressure of the abrasive material “M”.

Preferably, each array 8, 9 extends along the entire width “W” of the working area with a succession of nozzles 11, 12 such as to allow the engraving of all the points of the slab “S”.

Preferably, the nozzles 11, 12 are spaced apart from each other by no more than 20 mm; preferably the nozzles 11, 12 are placed at a mutual distance comprised between 5 and 15 mm, more preferably between 7 and 13 mm.

According to one aspect of the present invention, the machine 1 comprises a control unit 10 associated with the nozzles 11, 12 and configured to drive them independently of each other in order to adapt the engraving to the conformation of said predetermined engraving path “E”.

It should be noted that “independently” is intended to mean that at least the nozzles 11, 12 can be activated or deactivated independently of each other and depending on the area of the slab “S” instantly facing them.

The control unit 10 is thus configured to programme the activation of each nozzle according to the shape of the engraving path “E”.

More precisely, the control unit 10 is configured to activate the nozzles 11, 12 of the array 8, 9 (only) when they directly face a first portion of the slab “S”, and deactivate the nozzles 11, 12 of the array 8, 9 (or keep them deactivated) when they directly face a second portion of the slab

In this respect, the control unit 10 is configured to drive the pressure generators 15, associated with each nozzle 11, 12, in a mutually independent manner.

In other words, the control unit 10 is also configured to vary the delivery pressure of each nozzle 11, 12. In detail, the control unit 10 is operatively associated with the vacuum pump or generator of each nozzle and configured to drive it according to a reference signal related to the shape of the engraving path “E” to be carried out on the slab “S”.

This engraving path “E” can be preset by an operator, for example by selecting one of a plurality of possibilities that are stored in the system or acquired by processing the detected image (for example by scanning) of a reference slab.

Therefore, the machine 1 according to the present invention is particularly suitable for being used in replicating, on a building material, the tactile and visual effect of a natural stone scanned and processed through image processing programs.

In this view, in a preferred embodiment, the machine 1 is associated with (and sometimes comprises) an acquisition module (not shown) configured to detect and store the image of a reference article or model.

This acquisition module, in turn, is connected to a processing (or image processing) module configured to determine with certainty the position of the engravings on the slab “S”, i.e. the first portions, but also preferably their width and depth, as will become clearer hereinafter.

In this respect, it should be noted, in fact, that the engraving path “E” can provide the most varied shapes, dimensions and depths.

For example, the engravings made on the slab may provide a plurality of wide engravings E1 and a plurality of narrow engravings E2.

In addition, again by way of example, the engravings may be deep engravings E3 and a plurality of superficial engravings E4.

Therefore, the engraving variability that the machine 1 is able to obviate is linked, apart from the location, both to the width of the engraving and to its depth.

In this respect, the engraving device 4 comprises at least one array of first nozzles 11 and one array 9 of second nozzles 12, the arrays being arranged in succession along the direction of movement “A”.

In accordance with this, the engraving device 4 comprises at least a first reservoir 7a and a second reservoir 7b associated with the first nozzles 11 and second nozzles 12, respectively.

It should be noted that the first nozzles 11 preferably have a different size from the second nozzles 12, where “size” is understood to mean the transverse dimension, i.e. the material delivery section.

In other words, each nozzle 11, 12 has its own outlet 11a from which the abrasive material is delivered.

The outlet 11a of the first nozzles 11 has a section transverse to the delivery direction, which is different from the second nozzles 12.

Therefore, the first reservoir 7a and the second reservoir 7b are suitable for containing abrasive particulate material “M” of different particle sizes.

Preferably, the second nozzles 12 have a smaller size compared to the first nozzles 11.

In accordance with this, the second reservoir 7b contains abrasive material “M” of a smaller particle size compared to the first reservoir “M”.

More precisely, the first reservoir 7a contains a first abrasive particulate material “M” of a larger particle size compared to a second abrasive particulate material “M” contained in the second reservoir 7b.

In the preferred embodiment, the array 8 of first nozzles 11 is arranged, with respect to the direction of movement “A”, operatively upstream of the array 9 of second nozzles 12.

Therefore, while sliding along the direction of movement “A”, the slab “S” first encounters the first nozzles 11 and subsequently the second nozzles 12.

Advantageously, in this way it is possible to perform narrower grooves and/or machining operations at varying depths and widths, within a same engraving.

It should be noted that, in a further embodiment, the arrays of nozzles are at least three, respectively provided with a plurality of first 11, second 12 and third nozzles (not shown), all different in size from each other.

In this embodiment, therefore, the reservoirs, in turn, are at least three, i.e. a first 7a, a second 7b and a third reservoir (not shown), each containing an abrasive material having a particle size different from the others and consistent with the size of the respective first 11, second 12 and third nozzle (preferably of the entire relevant array).

Advantageously, such multi-array configuration makes the machining process even more flexible, allowing the conformation of the engraving path “E” to be even more varied.

In order to also allow an increased flexibility when making engravings of various depths, each nozzle 11, 12 of the array (i.e., of each array) is movable towards and/or away from the working plane 2, so as to vary the contact pressure of the particles of the abrasive particulate material “M” on the slab “S”.

It should be noted that in certain embodiments, not shown, the nozzles 11, 12 are movable towards and away from the working plane 2 in a mutually independent manner.

In the preferred embodiment, however, in order to simplify the control as well as the structure of the array, the array 8, 9 itself is movable towards and away from the working plane 2 so that it carries along the nozzles 11, 12.

Therefore, each nozzle 11, 12 of a same array is movable (preferably vertically) towards and away from the working plane 2 between a position proximal to the plane, in which the contact pressure between the abrasive material particles and the slab is maximum, and a position distal to the plane, in which the contact pressure between the abrasive material particles and the slab is minimal.

Therefore, the nozzles 11, 12 (or the arrays 8, 9) are movable towards the working plane 2 to increase the contact pressure and the depth of the engraving. In contrast, the nozzles 11, 12 (or the arrays 8, 9) are movable away from the working plane 2 to decrease the contact pressure and the depth of the engraving.

In this regard, each array of nozzles 11, 12 comprises a translating assembly 13, 14 associated with the nozzles 11, 12 and configured to move them towards and away from the working plane 2.

Preferably, the translating assembly 13, 14 comprises at least one actuator 13a.

For example, these actuators may be defined by electric motors associated with a respective nozzle 11, 12 by means of a drive and transmission system (e.g. rack-and-pinion).

Alternatively, again by way of example, the actuators may be electromagnetic, pneumatic (or even hydraulic, with the proper arrangements).

The control unit 10 is therefore associated with the nozzles 11, 12, and preferably with the respective translating assembly 13, 14, and configured for driving each nozzle 11, 12 (in particular each array 8, 9) towards or away from the working plane 2 depending on the desired depth of engraving of the slab in a given portion of the engraving path “E”.

The object of the present invention is also a method for engraving a building material slab, preferably a ceramic material.

Preferably, this method is implemented by using an engraving machine 1 also in accordance with the present invention; however, other machinery or systems may be used for the implementation of the engraving method described below.

However, for the parts of the description that are common between the machine and the method, such as for example the specifications of the slab or other specifications, in the description of the method, reference is made to what has been previously illustrated.

The engraving method, in fact, comprises providing a building material slab “S” on a working plane 2.

The slab “S” has already been described previously and, as said, is made of a building material, preferably a ceramic material or the like.

A predetermined engraving path “E” to be performed on the slab “S” is subsequently (or even previously or simultaneously) established in order to give the slab a desired appearance, be it defined by a drawing or a processing suitable for reproducing the appearance of a natural stone.

“Engraving path” may thus be understood as a set of lines defining images or writing, as well as a plurality of engravings mutually distributed on the face of the slab in a non-homogeneous and variable way; in this case, the engraving path may consist of a set of deep engravings E3 and superficial engravings E4, wide engravings E1 and narrow engravings E2, thus consisting of engravings arranged in sequence or in parallel along any direction.

In this regard, the method preferably includes preferentially acquiring an image related to a reference article or model and processing said image to determine the location, the local width and the local depth of each engraving.

The engraving device designed to implement the method is then driven according to this processing.

Preferably, the engraving device 4 is placed so that its nozzles 11, 12 face the working plane 2, in particular the slab “S”.

As already described above, the array of nozzles extends so as to fully cover the width “W” of the slab “S”.

More preferably, the array of nozzles 11, 12 extends along a direction transverse, preferably orthogonal, to the direction of movement between the slab “S” and the nozzles 11, 12 themselves.

According to one aspect of the present invention, the engraving device 4 is operated in a localised manner.

More precisely, this operation step comprises:

activating the nozzles 11, 12 of the array 8, 9 which directly face a first portion S1 of the slab “S”;

deactivating the nozzles 11, 12 of the array 8, 9 which directly face a second portion S2 of the slab “S”.

The first S1 and the second portion S2 have been described previously and respectively define one area of the slab to be engraved and one free of engravings.

Therefore, each nozzle 11, 12 is moved independently (and autonomously) of the others when it faces a portion of the engraving path “E”.

In other words, when the nozzle 11, 12 is in front of a portion of the engraving path “E” (or first portion S1), it is activated, the pressure and/or distance from the slab “S” being determined as a function of the engraving depth of the section to be engraved.

In contrast, when the nozzle 11, 12 is in front of a portion of the slab “S” devoid of sections to be engraved (or second portion S2), it is deactivated.

Therefore, in each relative position between the slab “S” and the nozzles 11, 12, the nozzles 11, 12 of a same array 8, 9 can indiscriminately be activated or deactivated depending on the shape of the engraving path “E”.

More precisely, in a preferred embodiment, the step of operating the nozzles 11, 12 comprises positioning each nozzle 11, 12 in a position proximal to the slab “S” to increase the contact pressure of the abrasive particulate material “M” and to make a deep engraving E3.

In accordance with this, the step of operating the nozzles 11, 12 comprises positioning each nozzle 11, 12 in a position distal to the slab “S” to decrease the contact pressure of the abrasive particulate material “M” and to make a superficial engraving E4.

Advantageously, this positioning flexibility allows the processing that can be performed on the slab “S” to be optimized and diversified, thus making the method suitable for performing engravings of various kinds.

Preferably, moreover, with reference to what has already been described in relation to the machine 1, the engraving device 4 comprises at least one array 8 of first nozzles 11, of a larger size, and one array 9 of second nozzles 12, of a smaller size.

It should be noted that “size” is understood to mean the transverse dimension, i.e. the material delivery section.

In other words, “size” can be referred to as the area and/or the cross-section of the outlet 11a of each nozzle 11, 12.

Preferably, the step of operating the nozzles 11, 12 comprises operating one or more first nozzles 11 for engraving a wide portion E1, and one or more second nozzles 12 for engraving a narrow portion E2 of the engraving path.

It should be noted that the second nozzles 12 (and the relevant array) are preferably operatively arranged downstream of the first nozzles 11 (and the relevant array), with respect to the direction of movement “A” between the slab and the engraving device.

Advantageously, in this way it is possible to further groove (i.e. deepen and/or cut steps into) a wide engraving E1 by activating, subsequently to its realization, a second nozzle 12.

The invention achieves the intended objects and attains important advantages.

In fact, the use of an engraving device able to locally engrave different areas of the slab, with varying thicknesses and depths allows a wide range of machining operations to be carried out without the need to provide preventive masks.

Moreover, by acting directly on the slab without the interposition of masks and by only activating the nozzles of interest for the engraving, it is possible to greatly reduce the consumption of abrasive material, and at the same time, keep the machining area “cleaner”.

1. A machine for engraving building material articles, preferably slabs, comprising:
a working plane (2) on which, in use, at least one building material article (S) rests, and defining a working area having a predetermined width (W);
an engraving device (4) facing the working plane (2) and provided with at least one reservoir (7a, 7b) for containing an abrasive particulate material (M), and an array (8, 9) of nozzles (11, 12) for delivering said abrasive particulate material (M) configured for making a predetermined engraving path (E) on said article (S);
moving means (5) configured to determine a relative sliding between said working plane (2) and said engraving device (4) along a movement direction (A) transverse to said predetermined width (W);
characterised in that the nozzles (11, 12) of said array (8, 9) are arranged in succession along a direction transverse to the movement direction (A) in order to fully cover said predetermined width (W), and in that it comprises a control unit (10) associated with said nozzles (11, 12) and configured to drive them independently of each other in order to adapt the engraving to the conformation of said predetermined engraving path (E).

2. The engraving machine according to claim 1, characterised in that said predetermined engraving path (E) defines on said article (S) a plurality of first portions (S1), to be engraved, and a plurality of second portions (S2), without engravings; said control unit (10) being configured to:
activate the nozzles (11, 12) of the array (8, 9) when they directly face a first portion (S1) of the article (S);
deactivate the nozzles (11, 12) of the array (8, 9) when they directly face a second portion (S2) of the article (S).

3. The engraving machine according to claim 1, characterised in that the engraving device (4) comprises at least one array (8) of first nozzles (11) and one array (9) of second nozzles (12), the arrays being arranged in succession along said movement direction (A), wherein the first nozzles (11) and the second nozzles (12) have different dimensions.

4. The engraving machine according to claim 3, characterised in that the second nozzles (12) have a smaller size compared to the first nozzles (11).

5. The engraving machine according to claim 3, characterised in that the engraving device (4) comprises at least a first reservoir (7a) and a second reservoir (7b) respectively associated with the first nozzles (11) and the second nozzles (12), wherein said first reservoir (7a) and second reservoir (7b) are suitable for containing abrasive particulate material (M) of different particle sizes.

6. The engraving machine according to claim 5, characterised in that the first reservoir (7a) contains a first abrasive particulate material of a larger particle size compared to a second abrasive particulate material contained in the second reservoir (7b).

7. The engraving machine according to any of the preceding claim 1, characterised in that each nozzle (11, 12) of said array (8, 9) is movable towards and/or away from said working plane (2) to vary the contact pressure of the particles of the abrasive particulate material (M) on the slab (S).

8. The engraving machine according to any of the preceding claim 1, characterised in that said engraving device (4) comprises a pressure generator (15) associated with each nozzle (11, 12); said control unit (10) being configured to drive said pressure generators (15) in a mutually independent way.

9. A method for engraving a building material article, comprising the steps of:
providing a building material article (S) on a working plane (2); said article (S) having a predetermined width (W);
determining a predetermined engraving path (E) to be made on said article (S) so that first portions (S1), to be engraved, and second portions (S2), without engravings, are defined on the article (S);
providing an engraving device (4) facing the working plane (2) and equipped with an array (8, 9) of nozzles (11, 12) configured for delivering an abrasive particulate material (M) on said article (S) in order to engrave it; said array (8, 9) of nozzles (11, 12) extending so as to substantially cover the whole of said predetermined width (W) of the article (S);
operating the nozzles (11, 12) for making said engraving path (E);
characterised in that said operating step comprises:
activating the nozzles (11, 12) of the array (8, 9) which directly face a first portion (S1) of the article (S);
deactivating the nozzles (11, 12) of the array (8, 9) which directly face a second portion (S2) of the article (S).

10. The engraving method according to claim 9, characterised in that each nozzle (11, 12) of the array (8, 9) is driven independently of each other.

11. The engraving method according to claim 9, characterised in that said array (8, 9) of nozzles (11, 12) extends along its own main direction; said method comprising moving the article (S) with respect to the array (8, 9) of nozzles (11, 12) along a movement direction (A) transverse to said main direction.

12. The engraving method according to any one of claim 9, characterised in that said engraving path (E) comprises a plurality of wide engravings (E1) and a plurality of narrow engravings (E2), and in that said engraving device (4) comprises at least one array (8) of first nozzles (11), of a larger size, and one array (9) of second nozzles (12), of a smaller size; said step of operating the nozzles (11, 12) comprising operating one or more first nozzles (11) to make a wide engraving (E1) and one or more second nozzles (12) to make a narrow engraving (E2).

13. The engraving method according to claim 9, characterised in that said engraving path (E) comprises a plurality of deep engravings (E3) and a plurality of superficial engravings (E4), wherein the step of operating the nozzles comprises:
positioning each array of nozzles (11, 12) in a position proximal to the article (S) to increase the contact pressure of the abrasive material (M) and to make a deep engraving (E1), and
positioning each array of nozzles (11, 12) in a position distal to the article (S) to reduce the contact pressure of the abrasive material (M) and to make a superficial engraving (E4).
